(19) United States
(12) Patent Application Publication
(10) Pub. No.: US 2010/0160204 A1
(43) Pub. Date: Jun. 24, 2010

(54) Detergents

(76) Inventors: Johannes Zipfel, Dusseldorf (DE); Nadine Warkotsch, Dusseldorf (DE); Arnd Kessler, Monheim am Rhein (DE); Christian Nitsch, Dusseldorf (DE)

Correspondence Address: Henkel Corporation, 10 Finderne Avenue, Bridgewater, NJ, 08807, US

(21) Appl. No.: 12/720,781

(22) Filed: Mar. 10, 2010

Related U.S. Application Data
(63) Continuation of application No. PCT/EP2008/061467, filed on Sep. 1, 2008.

(30) Foreign Application Priority Data
Sep. 10, 2007 (DE) 10 2007 042 860.1

(51) Int. Cl. C11D 3/37

(52) U.S. Cl. 510/220

(57) ABSTRACT

Dishwasher detergents containing: a) 10 to 60 percent by weight of a builder; and b) non-ionic surfactant of the general formula

R¹O[CH₂CH(CH₃)O]ₓ[CH₂CH₂O]_{y}[CH₂CH(CH₃)O]_{z}CH₂CH(OH)R²

wherein R¹ is a linear or branched aliphatic hydrocarbon radical having 4 to 22 carbon atoms or mixtures thereof, R² is a linear or branched hydrocarbon radical having 2 to 26 carbon atoms or mixtures thereof, x and z represent values between 0 and 40, and y represents a value of at least 15; c) anionic copolymer comprising: i) unsaturated carboxylic acids, ii) sulfonic acid group-containing monomers, wherein the weight ratio of components c) to b) is less than 3:1. In addition to exhibiting good cleaning and rinsing efficiency, dishwasher detergents according to the invention enhance the drying process of the cleaned dishes.

### CROSS REFERENCE TO RELATED APPLICATIONS

The present application is a continuation of International Patent Application No. PCT/EP2008/061467 filed 1 Sep. 2008, which claims priority to German Patent Application No. 10 2007 042 860.1 filed 10 Sep. 2007, both of which are incorporated herein by reference.

The present patent application describes cleaning agents, particularly cleaning agents for automatic cleaning of tableware. More particularly, the subject matter of this application is directed towards automatic dishwashing agents containing a combination of specific nonionic surfactants and anionic polymers.

Dishwashing agents are available to consumers in a variety of presentation forms. In addition to traditional liquid hand dishwashing agents, automatic dishwashing agents have gained significance with the widespread use of household automatic dishwashers. These automatic dishwashing agents are typically offered to the consumer in solid form, for example, as powders or tablets, but increasingly also in liquid form.

Manufacturers of automatic dishwashing agents often seek to improve the cleaning performance of such agents. Recently, attention has focused on cleaning performance in low-temperature cleaning cycles or in cleaning cycles with reduced water consumption. Preferably, new ingredients such as more-effective surfactants, polymers, or bleaching agents, are added to the cleaning agents for this purpose. However, since new ingredients are available only to a limited extent, and since there are environmental and economic reasons for restricting the amount of ingredients used for each cleaning cycle, there are natural limits to this approach.

In addition to cleaning and rinsing capability, drying is a further feature of automatic dishwashing agents. Drying of tableware typically occurs from residual heat of the tableware after the automatic cleaning process has ended; therefore, high-temperature cleaning processes are notable for improved drying compared to low-temperature cleaning process. High-temperature cleaning process have, however, elevated energy expenditure and, consequently, elevated costs for humans and the environment.

While consumer interest is increasingly focused on low-temperature cleanings because of their economic and environmental advantages, and as manufacturers of automatic dishwashers are increasingly addressing this customer demand by corresponding cleaning programs, a need therefore exists for manufacturers of automatic dishwashing agents to make available cleaning agents that, even under these modified boundary conditions (i.e., cleaning programs), and preferably over the entire range of boundary conditions represented on the market, exhibit a proven—and if possible improved—performance profile.

Against this technical background, the present invention makes available an automatic dishwashing agent that, even in low-temperature cleaning cycles or cleaning cycles with low water consumption, exhibits good cleaning and rinsing performance, as well as improved drying of the cleaned tableware.

This is achieved by an automatic dishwashing agent having a specific combination of nonionic surfactants and anionic polymers.

A first embodiment of the present invention is therefore an automatic dishwashing agent containing—

a) about 10 to about 60 wt % of one or more builders,

b) nonionic surfactant of the general formula

R¹O[CH₂CH(CH₃)O]_{X}[CH₂CH₂O]_{y}[CH₂CH(CH₃)O]_{Z}CH₂CH(OH)R²
wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; x and z are values from 0 to 40, and y is a value of at least 15, and

c) anionic copolymer comprising
i) unsaturated carboxylic acids, and
ii) sulfonic acid group-containing monomers,
   wherein the weight ratio of anionic copolymer and nonionic surfactant is less than 3:1.

As one ingredient, automatic dishwashing agents according to the present invention contain one or more builders. The weight proportion of builders to total weight of automatic dishwashing agents according to the present invention is preferably about 15 to about 50 wt %, and in particular about 20 to about 40 wt %. Included among the builders are carbonates, phosphates, organic cobuilders and silicates.

It is particularly preferred to use carbonate(s) and/or hydrogencarbonate(s), by preference alkali carbonate(s), particularly preferably sodium carbonate, in quantities from about 2 to about 30 wt %, by preference from about 3 to about 20 wt %, and in particular from about 4 to about 15 wt %, based on total weight of the automatic dishwashing agent.

Organic cobuilders include polycarboxylates/polycarboxylic acids, polymeric carboxylates, aspartic acid, polyacetals, dextrins, and organic cobuilders. These substance classes are described below.

Usable organic builder substances include polycarboxylic acids, which can be used in the form of the free acid and/or its sodium salts, “polycarboxylic acids” being understood as those carboxylic acids that carry more than one acid function. Examples are citric acid, adipic acid, succinic acid, glutaric acid, malic acid, tartaric acid, maleic acid, fumaric acid, sugar acids, aminocarboxylic acids, and nitrilotriacetic acid (NTA), provided such use is not objectionable for environmental reasons, as well as mixtures thereof. Free acids typically also have an acidifying component in addition to their builder effect, and thus also serve to establish a lower and milder pH for washing or cleaning agents. Worthy of mention in this context are, in particular, citric acid, succinic acid, glutaric acid, adipic acid, gluconic acid, and any mixtures thereof.

Particularly preferred automatic dishwashing agents according to the present invention contain citrate as one of their builders. Automatic dishwashing agents containing about 2 to about 40 wt %, preferably about 5 to about 30 wt %, and particularly about 7 to about 20 wt % citrate, are preferred. Citrate and citric acid, along with phosphates, are builders that, in combination with phosphonate, in particular 1-hydroxyethane-1,1-diphosphonic acid, and the sulfonic acid group-containing copolymers, are most effective in terms of cleaning performance, such as rinsing performance and in particular deposit inhibition.

Polycarboxylates are also suitable as organic builders. These are, for example, the alkali-metal salts of polyacrylic acid or of polymethacrylic acid, for example, those having a relative molecular weight from 500 to 70,000 g/mol.

Suitable polymers are, in particular, polyacrylates, preferably having a molecular weight from 2000 to 20,000 g/mol. Because of their superior solubility, short-chain polyacrylates having molar weights from 2000 to 10,000 g/mol, and particularly preferably from 3000 to 5000 g/mol, may in turn be preferred.

Also suitable are copolymeric polycarboxylates, in particular, those of acrylic acid with methacrylic acid, and acrylic acid or methacrylic acid with maleic acid. Copolymers of acrylic acid with maleic acid containing about 50 to about 90 wt % acrylic acid and about 50 to about 10 wt % maleic acid have proven particularly suitable. Their relative molecular weight, based on free acids, is generally about 2000 to about 70,000 g/mol, preferably about 20,000 to about 50,000 g/mol, and in particular about 30,000 to about 40,000 g/mol.

The concentration of (co)polymeric polycarboxylates in preferred automatic dishwashing agents is about 0.5 to about 20 wt %, and in particular about 3 to about 10 wt %.

Automatic dishwashing agents according to the present invention preferably contain, as a builder, crystalline sheet-form sodium silicates of the general formula NaMSiₓO₂ₓ₊₁.yH₂O wherein M is sodium or hydrogen; x is a number from 1.9 to 22, by preference from 1.9 to 4, particularly preferred values for x being 2, 3, or 4; and y is a number from 0 to 33, by preference from 0 to 20.

In addition to citrates, phosphates have proven to be effective builders in terms of cleaning performance. Among the many commercially obtainable phosphates, alkali-metal phosphates have the greatest significance in the washing- and cleaning-agent industry, particularly pentasodium or pentapotassium triphosphate (sodium or potassium tripolyphosphate).

“Alkali-metal phosphates” is the summary designation for the alkali-metal (particularly sodium and potassium) salts of the various phosphoric acids, in which context a distinction can be made between metaphosphoric acids (HPO₃)ₙ and orthophosphoric acid H₃PO₄, in addition to higher-molecular-weight representatives. Phosphates have a combination of advantages: they act as alkali carriers, prevent lime deposits on machine parts and lime incrustations in fabrics, and furthermore contribute to cleaning performance.

Phosphates that are technically especially important are pentasodium triphosphate Na₅P₃O₁₀ (sodium tripolyphosphate) and the corresponding potassium salt pentapotassium triphosphate K₅P₃O₁₀ (potassium tripolyphosphate). The sodium potassium tripolyphosphates are also used with preference according to the present invention.

If phosphates are used for washing or cleaning activity in washing or cleaning agents according to the present invention, preferred agents contain phosphate(s), preferably alkali-metal phosphate(s), particularly preferably pentasodium or pentapotassium triphosphate (sodium or potassium tripolyphosphate) in quantities from about 2 to about 50 wt %, preferably from 2 to about 30 wt %, and particularly from about 3 to about 25 wt %, particularly preferably from about 3 to about 15 wt %, based in each case on the weight of the washing or cleaning agent.

Also usable are amorphous sodium silicates having a Na₂O:SiO₂ modulus from 1:2 to 1:3.3, preferably from 1:2 to 1:2.8, and in particular from 1:2 to 1:2.6, which by preference are dissolution-delayed and exhibit secondary washing properties.

In preferred automatic dishwashing agents according to the present invention, silicates content, based on total weight of the automatic dishwashing agent, is limited to quantities of about 10 wt % or less, preferably about 5 wt % or less, and in particular about 2 wt % or less. Preferably, automatic dishwashing agents according to the present invention are silicate-free.

Automatic dishwashing agents according to the present invention can contain the aforementioned builders both individually and as mixtures of two, three, four or more builders.

As a supplement to the aforesaid builders, agents according to the present invention can contain alkali-metal hydroxides. These alkali carriers are used in cleaning agents preferably only in small quantities, by preference in quantities of about 10 wt % or less, preferably about 6 wt % or less, by preference about 5 wt % or less, particularly preferably from about 0.1 to about 5 wt %, and in particular from about 0.5 to about 5 wt %, based on total weight of the cleaning agent.

Particularly preferred automatic dishwashing agents contain at least two builders from phosphates, carbonates, and citrates, the weight proportion of these builders being about 2 to about 50 wt %, preferably about 5 to about 40 wt %, and in particular about 10 to about 30 wt %, based on total weight of the automatic dishwashing agent. The combination of the above two of more builders has proven to be advantageous for the cleaning and rinsing performance of automatic dishwashing agents according to the present invention.

Examples of formulations of automatic dishwashing agents according to the present invention are illustrated in the tables below:

| | Formu- | Formu- | Formu- | Formu- |
|---|---|---|---|---|
| | lation 1 | lation 2 | lation 3 | lation 4 |
| Ingredient | (wt %) | (wt %) | (wt %) | (wt %) |
| Tripolyphosphate | 5 to 50 | 5 to 35 | — | — |
| Citrate | — *** | — | 5 to 30 | 5 to 20 |
| Carbonate | 2 to 45 | 2 to 35 | 2 to 45 | 2 to 35 |
| Nonionic surfactant * | 0.1 to 15 | 0.2 to 10 | 0.5 to 8 | 1 to 6 |
| Anionic copolymer ** | 0.1 to 20 | 0.1 to 20 | 0.1 to 20 | 0.1 to 20 |
| miscellaneous | to 100 | to 100 | to 100 | to 100 |

| | Formu- | Formu- | Formu- | Formu- |
|---|---|---|---|---|
| | lation 5 | lation 6 | lation 7 | lation 8 |
| Ingredient | (wt %) | (wt %) | (wt %) | (wt %) |
| Potassium | 5 to 50 | 5 to 35 | — | — |
| tripolyphosphate | | | | |
| Citrate | — *** | — | 5 to 30 | 5 to 20 |
| Sodium carbonate | 2 to 45 | 2 to 35 | 2 to 45 | 2 to 35 |
| Nonionic surfactant * | 0.1 to 15 | 0.2 to 10 | 0.5 to 8 | 1 to 6 |
| Anionic copolymer ** | 0.1 to 20 | 0.1 to 20 | 0.1 to 20 | 0.1 to 20 |
| miscellaneous | to 100 | to 100 | to 100 | to 100 |

R¹O[CH₂CH(CH₃)O]ₓ[CH₂CH₂O]_{y}[CH₂CH(CH₃)O]_{z}CH₂CH(OH)R²

wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; x and z are values from 0 to 40, and y is a value of at least 15.
**Anionic copolymer comprising

i) unsaturated carboxylic acid(s),

ii) sulfonic acid group-containing monomer(s)

***“--” means, in this and in all tables hereinafter, that the formulation contains none of this constituent.

As a second component, dishwashing agents according to the present invention contain nonionic surfactants of the general formula

R¹O[CH₂CH(CH₃)O]ₓ[CH₂CH₂O]_{y}[CH₂CH(CH₃)O]_{Z}CH₂CH(OH)R²

The addition of surfactants has proven advantageous especially with regard to rinsing performance and drying. In a preferred embodiment, the automatic dishwashing agent contains nonionic surfactants of the general formula

R¹O[CH₂CH(CH₃)O]ₓ[CH₂CH₂O]_{y}[CH₂CH(CH₃)O]_{z}CH₂CH(OH)R²

in quantities from about 0.1 to about 35 wt %, by preference about 0.2 to about 10 wt %, particularly preferably about 0.5 to about 8 wt %, and in particular from about 1.0 to about 6 wt %, based on total weight of the agent.

Surfactants of the general formula

R¹—CH(OH)CH₂O-(AO)_{w}-(A′O)ₓ-(A″O)_{y}-(A″′O)_{z}—R²

wherein R¹ and R² are mutually independently a straight-chain or branched, saturated or mono- or polyunsaturated C₂₋₄₀ alkyl or alkenyl residue; A, A′, A″ and A″′ are mutually independently a residue from the group —CH₂CH₂, —CH₂CH₂—CH₂, —CH₂—CH(CH₃), —CH₂—CH₂—CH₂—CH₂, —CH₂—CH(CH₃)—CH₂—, and —CH₂—CH(CH₂—CH₃); and w, x, y and z are values from 0.5 to 90, wherein x, y, and/or z can also be 0, are preferred according to the present invention.

Particularly preferred are end-capped poly(oxyalkylated) nonionic surfactants according to the formula R¹O[CH₂CH₂O]_{y}CH₂CH(OH)R² wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; and y is a value from 15 to 120, preferably 20 to 100, in particular 20 to 80. Such nonionic surfactants include hydroxy mixed ethers of the general formula C₆₋₂₂—CH(OH)CH₂O-(EO)₂₀₋₁₂₀—C₂₋₂₆, for example, C₈₋₁₂ fatty alcohol-(EO)₂₂-2-hydroxydecylethers and C₄₋₂₂ fatty alcohol-(EO)₄₀₋₈₀-2-hydroxyalkylethers.

Also preferred are surfactants of the formula

R¹O[CH₂CH(CH₃)O]ₓ[CH₂CH₂O]_{y}CH₂CH(OH)R²

wherein R¹ is a linear or branched aliphatic hydrocarbon residue having 4 to 22 carbon atoms, or mixtures thereof, R² is a linear or branched hydrocarbon residue having 2 to 26 carbon atoms, or mixtures thereof; x is a value from 0.5 to 4, preferably 0.5 to 15 and y is a value of at least 15.

Additionally preferred according to the present invention are surfactants of the general formula

R¹O[CH₂CH(CH₃)O]ₓ[CH₂CH₂O]_{y}CH₂CH(OH)R²

wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; x is a value from 1 to 40; and y is a value from 15 to 40, wherein the alkylene units [CH₂CH(CH₃)O] and [CH₂CH₂O] are present in randomized fashion (i.e., in the form of a statistical, random distribution).

Preferred end-capped poly(oxyalkylated) nonionic surfactants b) also include nonionic surfactants of the formula

R¹O[CH₂CH₂O]_{X}[CH₂CH(R³)O]_{y}CH₂CH(OH)R²

wherein R¹ and R² are mutually independently a linear or branched, saturated or mono- or polyunsaturated hydrocarbon residue having 2 to 26 carbon atoms; R³ is —CH₃, —CH₂CH₃, —CH₂CH₂—CH₃, or —CH(CH₃)₂, preferably —CH₃; and x and y are mutually independently values from 1 to 32, wherein nonionic surfactants in which R³═—CH₃, x is a value from 15 to 32 and y is a value from 0.5 to 1.5 are very particularly preferred.

By utilizing nonionic surfactants described above having a free hydroxyl group on one of the two terminal alkyl residues, rinsing results and drying can be considerably improved compared to conventional polyalkoxylated fatty alcohols without a free hydroxyl group.

Carbon chain lengths and degrees of ethoxylation or alkoxylation stated for the above nonionic surfactants represent statistical averages that can be a whole number or a fractional number for a specific product. As a result of production process, commercial products of the above formulas are usually made up not of one individual representative but rather of mixtures, so that average values and, as a consequence, fractional numbers, can result both for the carbon chain lengths and for the degrees of ethoxylation and alkoxylation.

The above nonionic surfactants can be used not only as individual substances, but also as surfactant mixtures of two, three, four, or more surfactants. “Surfactant mixtures” refers here not to mixtures of nonionic surfactants that fall, in their totality, under one of the above general formulas, but instead to those mixtures containing two, three, four, or more nonionic surfactants that can be described by different ones of the aforesaid, or other, general formulas.

Nonionic surfactants b) having a melting point above room temperature are particularly preferred. Nonionic surfactant(s) b) having a melting point of about 20° C. or greater, by preference about 25° C. or greater, particularly preferably from about 25 to about 60° C., and in particular from about 26.6 to about 43.3° C., is/are particularly preferred.

A third component of automatic dishwashing agents according to the present invention is the sulfonic acid group-containing copolymers c), which, in addition to sulfonic acid group-containing monomer(s), include at least one unsaturated carboxylic acid. Copolymers c) can have two, three, four, or more different monomer units. Preferred automatic dishwashing agents contain this polymer c) in quantities from about 0.2 to about 18 wt %, preferably about 0.5 to about 15 wt %, and in particular about 1.0 to about 12 wt %, based on total weight of the agent.

Unsaturated carboxylic acids of the formula R¹(R²)C═C(R³)COOH wherein R¹ to R³ are mutually independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or are —COOH or —COOR⁴ where R⁴ is a saturated or unsaturated, straight-chain or branched hydrocarbon residue having 1 to 12 carbon atoms, are particularly preferred.

An automatic dishwashing agent containing

a) about 10 to about 60 wt % of one or more builders,

b) nonionic surfactant of the general formula

R¹O[CH₂CH(CH₃)O]_{X}[CH₂CH₂O]_{y}[CH₂CH(CH₃)O]_{Z}CH₂CH(OH)R²
wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; x and z are values from 0 to 40; and y is a value of at least 15,

c) 0.1 to 20 wt % anionic copolymer comprising
i) carboxyl group-containing monomers of the formula R¹(R²)C═C(R³)COOH wherein R¹ to R³ are mutually independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or are —COOH or —COOR⁴ where R⁴ is a saturated or unsaturated, straight-chain or branched hydrocarbon residue having 1 to 12 carbon atoms,
ii) sulfonic acid group-containing monomer(s),
   is therefore particularly preferred.

Particularly preferred unsaturated carboxylic acids include acrylic acid, methacrylic acid, ethacrylic acid, [symbol] -chloroacrylic acid, [symbol] -cyanoacrylic acid, crotonic acid, [symbol] -phenylacrylic acid, maleic acid, maleic acid anhydride, fumaric acid, itaconic acid, citraconic acid, methylenemalonic acid, sorbic acid, cinnamic acid, or mixtures thereof. Unsaturated dicarboxylic acids are, of course, also usable.

Among the sulfonic acid group-containing monomers, those of the formula

R⁵(R⁶)C═C(R⁷)—X—SO₃H

wherein R⁵ to R⁷ are mutually independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH, or —COOH, or are —COOH or —COOR⁴ where R⁴ is a saturated or unsaturated, straight-chain or branched hydrocarbon residue having 1 to 12 carbon atoms; and X is an optional spacer group chosen from —(CH₂)ₙ— where n=0 to 4, —COO—(CH₂)ₖ— where k=1 to 6, —C(O)—NH—C(CH₃)₂—, and —C(O)—NH—CH(CH₂CH₃)—, are preferred.

Among these monomers, those of the formulas

H₂C═CH—X—SO₃H

H₂C═C(CH₃)—X—SO₃H

HO₃S—X—(R⁶)C═C(R⁷)—X—SO₃—H

wherein R⁶ and R⁷ are mutually independently —H, —CH₃, —CH₂CH₃, —CH₂CH₂CH₃—, or —CH(CH₃)₂, and X is an optional spacer group chosen from —(CH₂)ₙ— where n=0 to 4, —COO—(CH₂)ₖ— where k=1 to 6, —C(O)—NH—C(CH₃)₂—, and —C(O)—NH—CH(CH₂CH₃)—, are preferred.

Particularly preferred sulfonic acid group-containing monomers in this context are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropylacrylate, 3-sulfopropylmethacrylate, sulfomethacrylamide, sulfomethylmethacrylamide, and mixtures of the aforesaid acids or water-soluble salts thereof.

Sulfonic acid groups can exist in the polymers in partly or entirely neutralized form (i.e., the acid hydrogen atom of the sulfonic acid group can, in some or all sulfonic acid groups, be exchanged for metal ions, by preference alkali-metal ions, and in particular for sodium ions). Use of partly or entirely neutralized sulfonic acid group-containing copolymers is preferred according to the present invention.

In copolymers containing only monomers from groups i) and ii), the monomer distribution of the copolymers used in preferred fashion according to the present invention is by preference respectively 5 to 95 wt % i) and ii), respectively, particularly preferably 50 to 90 wt % monomer from group ii) and 10 to 50 wt % monomer from group i), each based on the polymer.

Molar weight of sulfo-copolymers used according to the present invention can be varied in order to adapt the properties of the polymers to the desired application. Preferred automatic dishwashing agents have copolymers having molar weights from about 2000 to about 200,000 gmol⁻¹, preferably from about 4000 to about 25,000 gmol⁻¹, and in particular from about 5000 to about 15,000 gmol⁻¹.

An automatic dishwashing agent containing

a) about 10 to about 60 wt % of one or more builders,

b) nonionic surfactant of the general formula

R¹O[CH₂CH(CH₃)O]ₓ[CH₂CH₂O]_{y}[CH₂CH(CH₃)O]_{Z}CH₂CH(OH)R²
wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; x and z are values from 0 to 40, and y is a value of at least 15,

c) 0.1 to 20 wt % anionic copolymer comprising
i) carboxyl group-containing monomers of the formula R¹(R²)C═C(R³)COOH wherein R¹ to R³ are mutually independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or are —COOH or —COOR⁴ where R⁴ is a saturated or unsaturated, straight-chain or branched hydrocarbon residue having 1 to 12 carbon atoms,
ii) sulfonic acid group-containing monomer(s) of the formula R⁵(R⁶)C═C(R⁷)—X—SO₃H wherein R⁵ to R⁷ are mutually independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH, or —COOH, or are —COOH or —COOR⁴ where R⁴ is a saturated or unsaturated, straight-chain or branched hydrocarbon residue having 1 to 12 carbon atoms, and X is an optional spacer group chosen from —(CH₂)ₙ— where n=0 to 4, —COO—(CH₂)ₖ— where k=1 to 6, —C(O)—NH—C(CH₃)₂—, and —C(O)—NH—CH(CH₂CH₃)—,
   is therefore also particularly preferred according to the present invention.

Examples of formulations for preferred automatic dishwashing agents according to the present invention are illustrated in the tables below:

| | Formu- | Formu- | Formu- | Formu- |
|---|---|---|---|---|
| | lation 9 | lation 10 | lation 11 | lation 12 |
| Ingredient | (wt %) | (wt %) | (wt %) | (wt %) |
| Tripolyphosphate | 5 to 50 | 5 to 35 | 5 to 55 | 5 to 35 |
| Carbonate | 2 to 45 | 2 to 35 | 2 to 35 | 2 to 35 |
| Nonionic surfactant* | 0.1 to 15 | 0.2 to 10 | 0.5 to 8 | 1 to 6 |
| Anionic copolymer** | 0.1 to 20 | 0.2 to 18 | 0.5 to 15 | 1 to 12 |
| miscellaneous | to 100 | to 100 | to 100 | to 100 |

| | Formu- | Formu- | Formu- | Formu- |
|---|---|---|---|---|
| | lation 13 | lation 14 | lation 15 | lation 16 |
| Ingredient | (wt %) | (wt %) | (wt %) | (wt %) |
| Potassium | 5 to 50 | 5 to 35 | 5 to 55 | 5 to 35 |
| tripolyphosphate | | | | |
| Sodium carbonate | 2 to 45 | 2 to 35 | 2 to 35 | 2 to 35 |
| Nonionic surfactant* | 0.1 to 15 | 0.2 to 10 | 0.5 to 8 | 1 to 6 |
| Anionic copolymer** | 0.1 to 20 | 0.2 to 18 | 0.5 to 15 | 1 to 12 |
| miscellaneous | to 100 | to 100 | to 100 | to 100 |

R¹O[CH₂CH(CH₃)O]ₓ[CH₂CH₂O]_{y}[CH₂CH(CH₃)O]_{z}CH₂CH(OH)R²

wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; x and z are values from 0 to 40, and y is a value of at least 15.
**Anionic copolymer comprising
i) carboxyl group-containing monomers of the formula R¹(R²)C═C(R³)COOH wherein R¹ to R³ are mutually independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues as defined above substituted with —NH₂, —OH, or —COOH, or are —COOH or —COOR⁴ where R⁴ is a saturated or unsaturated, straight-chain or branched hydrocarbon residue having 1 to 12 carbon atoms, and
ii) sulfonic acid group-containing monomer(s) of the formula R⁵(R⁶)C═C(R⁷)—X—SO₃H wherein R⁵ to R⁷ are mutually independently —H, —CH₃, a straight-chain or branched saturated alkyl residue having 2 to 12 carbon atoms, a straight-chain or branched, mono- or polyunsaturated alkenyl residue having 2 to 12 carbon atoms, alkyl or alkenyl residues substituted with —NH₂, —OH, or —COOH, or are —COOH or —COOR⁴ where R⁴ is a saturated or unsaturated, straight-chain or branched hydrocarbon residue having 1 to 12 carbon atoms, and X is an optional spacer group chosen from —(CH₂)ₙ— where n=0 to 4, —COO—(CH₂)ₖ— where k=1 to 6, —C(O)—NH—C(CH₃)₂—, and —C(O)—NH—CH(CH₂CH₃)—.

In a further preferred embodiment, copolymers c) also include, alongside carboxyl group-containing monomers and sulfonic acid group-containing monomers, at least one nonionic, preferably hydrophobic monomer. Use of these hydrophobically modified polymers improves, in particular, the rinsing performance of automatic dishwashing agents according to the present invention.

Automatic dishwashing agents, wherein the automatic dishwashing agent contains as an anionic polymer c) a copolymer comprising —

i) unsaturated carboxylic acid(s),

ii) sulfonic acid group-containing monomer(s), and

iii) further nonionogenic monomer(s),

are preferred according to the present invention

Nonionic monomers used preferably are monomers of the general formula R¹(R²)C═C(R³)—X—R⁴ wherein R¹ to R³ are mutually independently —H, —CH₃, or —C₂H₅, X is an optional spacer group chosen from —CH₂—, —C(O)O—, and —C(O)—NH—, and R⁴ is a straight-chain or branched saturated alkyl residue having 2 to 22 carbon atoms or an unsaturated, by preference aromatic residue having 6 to 22 carbon atoms.

A further preferred embodiment of the present invention is therefore an automatic dishwashing agent containing—

a) about 10 to about 60 wt % of one or more builders,

b) nonionic surfactant of the general formula

R¹O[CH₂CH(CH₃)O]ₓ[CH₂CH₂O]_{y}[CH₂CH(CH₃)O]_{Z}CH₂CH(OH)R²
wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; x and z are values from 0 to 40, and y is a value of at least 15,

c) about 0.1 to about 20 wt % of an anionic copolymer comprising
i) unsaturated carboxylic acid(s),
ii) sulfonic acid group-containing monomer(s), and
iii) monomers of the general formula R¹(R²)C═C(R³)—X—R⁴ wherein R¹ to R³ are mutually independently —H, —CH₃, or —C₂H₅, X is an optional spacer group chosen from —CH₂—, —C(O)O—, and —C(O)—NH—, and R⁴ is a straight-chain or branched saturated alkyl residue having 2 to 22 carbon atoms or an unsaturated, by preference aromatic residue having 6 to 22 carbon atoms.

Particularly preferred nonionic monomers include butene, isobutene, pentene, 3-methylbutene, 2-methylbutene, cyclopentene, hexene, hexene-1,2-methlypentene-1,3-methlypentene-1, cyclohexene, methylcyclopentene, cycloheptene, methylcyclohexene, 2,4,4-trimethylpentene-1,2,4,4-trimethylpentene-2,2,3-dimethylhexene-1,2,4-dimethylhexene-1,2,5-dimethlyhexene-1,3,5-dimethylhexene-1,4,4-dimethylhexane-1, ethylcyclohexyne, 1-octene, [symbol] -olefins having 10 or more carbon atoms such as, for example, 1-decene, 1-dodecene, 1-hexadecene, 1-octadecene, and C22- [symbol] -olefin, 2-styrene, [symbol] -methylstyrene, 3-methylstyrene, 4-propylstryene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid 2-ethylhexyl ester, methacrylic acid 2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester, and N-(behenyl)acrylamide, or mixtures thereof.

With regard to rinsing performance and drying of the tableware, a weight ratio of anionic copolymer c) and nonionic surfactant b) of about 2.8:1 or less has proven advantageous, especially for low-temperature cleaning processes. The weight ratio of anionic copolymer c) and nonionic surfactant b) refers to the ratio to one another of anionic copolymer c) and nonionic surfactant b), based on total weight of the automatic dishwashing agent. With a weight ratio of anionic copolymer c) to nonionic surfactant b) of about 3:1 or less, the weight proportion of surfactant b) should therefore equal at least one-third of the weight proportion of anionic polymer c). For a weight proportion of anionic polymer equal to about 9 wt % of the total weight of the automatic dishwashing agent, the weight proportion of the surfactant is therefore at least about 3 wt % of the total weight of the automatic dishwashing agent.

Automatic dishwashing agents according to one of the preceding claims, wherein the weight ratio of anionic copolymer c) and nonionic surfactant b) is about 2.8:1 or less, by preference about 2.5:1 or less, particularly preferably about 2.2:1 or less, and in particular from about 2.2:1 to about 1:10, are preferred according to the present invention.

As a further ingredient, automatic dishwashing agents according to the present invention can contain phosphonate(s). The weight proportion of phosphonate, based on total weight of the automatic dishwashing agent, is about 0.5 to about 10 wt %, preferably about 1.0 to about 9 wt %, and in particular about 1.5 to about 7 wt %, particularly preferably about 2.0 to about 5 wt %.

Surprisingly, use of phosphonates improves cleaning performance on bleachable stains, particularly in weight proportions of phosphonate of about 1.5 wt % or greater based on total weight of the automatic dishwashing agent. This particularly applies to bleaching agent-free automatic dishwashing agents.

Complexing phosphonates include a number of different compounds such as 1-hydroxyethane-1,1-diphosphonic acid (HEDP) or diethylenetriaminepenta(methylenephosphonic acid) (DTPMP). Hydroxyalkane- and aminoalkanephosphonates are particularly preferred in this application. Among the hydroxyalkanephosphonates, 1-hydroxyethane-1,1-diphosphonate (HEDP) is of particular importance as a cobuilder. It is preferably used as a sodium salt, the disodium salt reacting neutrally and the tetrasodium salt in alkaline fashion (pH 9). Suitable aminoalkanephosphonates include ethylenediaminetetramethylenephosphonate (EDTMP), diethylenetriaminepentamethylenephosphonate (DTPMP), and their higher homologs. They are preferably used in the form of the neutrally reacting sodium salts (e.g., as a hexasodium salt of EDTMP or as a hepta- and octasodium salt of DTPMP). Of the class of the phosphonates, HEDP is preferably used.

An automatic dishwashing agent preferred in the context of this invention contains one or more phosphonate(s) from—
a) aminotrimethylenephosphonic acid (ATMA) and/or salts thereof,
b) ethylenediaminetetra(methylenephosphonic acid) (EDTMP) and/or salts thereof,
c) diethylenetriaminepenta(methylenephosphonic acid) (DTPMP) and/or salts thereof,
d) hydroxyethane-1,1-diphosphonic acid (HEDP) and/or salts thereof,
e) phosphonobutane-1,2,4-tricarboxylic acid (PBTC) and/or salts thereof,
f) hexamethylenediaminetetra(methylenephosphonic acid) (HDTMP) and/or salts thereof, and
g) nitrilotri(methylenephosphonic acid) (NTMP) and/or salts thereof.

Automatic dishwashing agents containing 1-hydroxyethane-1,1-diphosphonic acid (HEDP) or diethylenetriaminepenta(methylenephosphonic acid) (DTPMP) as phosphonates are particularly preferred.

Automatic dishwashing agents containing 1-hydroxyethane-1,1-diphosphonic acid (HEDP) as a phosphonate are particularly preferred according to the present invention.

Examples of formulations for preferred automatic dishwashing agents according to the present invention are illustrated in the tables below:

| | Formu- | Formu- | Formu- | Formu- |
|---|---|---|---|---|
| | lation 17 | lation 18 | lation 19 | lation 20 |
| Ingredient | (wt %) | (wt %) | (wt %) | (wt %) |
| Tripolyphosphate | 5 to 50 | 5 to 35 | 5 to 55 | 5 to 35 |
| Carbonate | 2 to 45 | 2 to 35 | 2 to 35 | 2 to 35 |
| Nonionic surfactant * | 0.1 to 15 | 0.2 to 10 | 0.5 to 8 | 1 to 6 |
| Anionic copolymer ** | 0.1 to 20 | 0.2 to 18 | 0.5 to 15 | 1 to 12 |
| Phosphonate | 0.5 to 10 | 1 to 9 | 1.5 to 7 | 2.0 to 5 |
| miscellaneous | to 100 | to 100 | to 100 | to 100 |

| | Formu- | Formu- | Formu- | Formu- |
|---|---|---|---|---|
| | lation 21 | lation 22 | lation 23 | lation 24 |
| Ingredient | (wt %) | (wt %) | (wt %) | (wt %) |
| Potassium | 5 to 50 | 5 to 35 | 5 to 55 | 5 to 35 |
| tripolyphosphate | | | | |
| Sodium carbonate | 2 to 45 | 2 to 35 | 2 to 35 | 2 to 35 |
| Nonionic surfactant * | 0.1 to 15 | 0.2 to 10 | 0.5 to 8 | 1 to 6 |
| Anionic copolymer ** | 0.1 to 20 | 0.2 to 18 | 0.5 to 15 | 1 to 12 |
| Phosphonate | 0.5 to 10 | 1 to 9 | 1.5 to 7 | 2.0 to 5 |
| miscellaneous | to 100 | to 100 | to 100 | to 100 |

R¹O[CH₂CH(CH₃)O]ₓ[CH₂CH₂O]_{y}[CH₂CH(CH₃)O]_{z}CH₂CH(OH)R²

wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; x and z are values from 0 to 40, and y is a value of at least 15.
**Anionic copolymer comprising

i) unsaturated carboxylic acid(s), and

ii) sulfonic acid group-containing monomer(s).

As an alternative to phosphonates, methylglycinediacetic acid (MGDA) can also be used in automatic dishwashing agents according to the present invention as a complexing agent. Phosphonate, however, is preferred over MGDA because phosphonates provide considerably better cleaning results on bleachable stains, as well as improved rinsing results.

An alternative embodiment of the present invention is therefore an automatic dishwashing agent containing—

a) about 10 to about 60 wt % of one or more builders,
b) nonionic surfactant of the general formula

R¹O[CH₂CH(CH₃)O]ₓ[CH₂CH₂O]_{y}[CH₂CH(CH₃)O]_{z}CH₂CH(OH)R²
wherein R¹ is a linear or branched aliphatic hydrocarbon residue having 4 to 22 carbon atoms, or mixtures thereof; R² designates a linear or branched hydrocarbon residue having 2 to 26 carbon atoms, or mixtures thereof; and x and z denote values between 0 and 40, and y denotes a value of at least 15,
   c) anionic copolymer comprising

i) unsaturated carboxylic acids, and

ii) sulfonic acid group-containing monomers,

wherein the weight ratio of anionic copolymer c) and nonionic surfactant b) is less than 3:1, and the automatic dishwashing agent further contains MGDA. Preferred cleaning agents contain MGDA in quantities of about 10 wt % or greater, preferably about 15 wt % or greater, based on total weight of the automatic dishwashing agent.

In order to increase cleaning performance, dishwashing agents according to the present invention can also contain enzymes. These include proteases, amylases, lipases, hemicellulases, cellulases, perhydrolases, or oxidoreductases, as well as preferably mixtures thereof. These enzymes are, in principle, of natural origin. Improved variants based on the natural molecules are available for use in washing and cleaning agents and are correspondingly preferred for use. Washing or cleaning agents contain enzymes preferably in amounts from about 1×10⁻⁶ to about 5 wt %, based on active protein. Protein concentration can be determined by known processes such as the BCA process or biuret process.

Among the proteases, those of the subtilisin type are preferred. Examples thereof are subtilisins BPN′ and Carlsberg and their further-developed forms, protease PB92, subtilisins 147 and 309, the alkaline protease from Bacillus lentus, subtilisin DY, and the enzymes (to be classified, however, as subtilases and no longer as subtilisins in the narrower sense) thermitase, proteinase K, and proteases TW3 and TW7.

Examples of useful amylases are α-amylases from Bacillus licheniformis, B. amyloliquefaciens, B. stearothermophilus, Aspergillus niger, and A. oryzae, and further developments of these amylases improved for use in washing and cleaning agents. Particularly for this purpose are the α-amylase from Bacillus sp. A 7-7 (DSM 12368) and the cyclodextrin-glucanotransferase (CGTase) from B. agaradherens (DSM 9948).

Additionally useful are lipases or cutinases, particularly because of their triglyceride-cleaving activities as well as to generate peracids in situ from suitable precursors. These include, for example, lipases obtainable originally from Humicola lanuginosa (Thermomyces lanuginosus) or further-developed lipases, particularly those having the D96L amino acid exchange. Also usable, for example, are cutinases originally isolated from Fusarium solani pisi and Humicola insolens. Also usable are lipases and cutinases whose starting enzymes were originally isolated from Pseudomonas mendocina and Fusarium solanii, respectively.

It is also possible to use enzymes termed “hemicellulases.” These include mannanases, xanthanlyases, pectinlyases (=pectinases), pectinesterases, pectatelyases, xyloglucanases (=xylanases), pullulanases, and β-glucanases.

To enhance the bleaching effect, oxidoreductases (e.g., oxidases, oxygenases, catalases, peroxidases such as halo-, chloro-, bromo-, lignin, glucose, or manganese peroxidases, dioxygenases, or laccases (phenoloxidases, polyphenoloxidases)) can be used. Advantageously, preferably organic, particularly preferably aromatic compounds that interact with the enzymes are additionally added in order to intensify the activity of the relevant oxidoreductases (enhancers) or, if there is a large difference in redox potentials between the oxidizing enzymes and the stains, to ensure electron flow (mediators).

A protein and/or enzyme can be protected, especially during storage, from damage such as inactivation, denaturing, or decomposition (e.g., resulting from physical influences, oxidation, or proteolytic cleavage). Inhibition of proteolysis is particularly preferred in microbial recovery of proteins and/or enzymes, particularly when the agents also contain proteases. Washing or cleaning agents can contain stabilizers for this purpose; the provision of such agents represents a preferred embodiment of the present invention.

Those automatic dishwashing agents containing, based on total weight of the agent, about 0.1 to about 12 wt %, by preference about 0.2 to about 10 wt %, and in particular about 0.5 to about 8 wt % enzyme preparations, are particularly preferred.

Proteases and amylases having washing or cleaning activity are typically available not in the form of the pure protein, but instead in the form of stabilized, storable and transportable preparations. Included among these prepackaged preparations are solid preparations obtained by granulation, extrusion, or lyophilization or, especially in the case of liquid or gelled agents, solutions of the enzymes, advantageously as concentrated as possible, low in water, and/or with stabilizers or further adjuvants added.

Alternatively, the enzymes can be encapsulated for both solid and liquid administration, for example, by spray-drying or extruding the enzyme solution together with a preferably natural polymer, or in the form of capsules, for example, those in which the enzymes are enclosed (e.g., in a solidified gel, or in a core-shell type in which an enzyme-containing core is covered with a protective layer impermeable to water, air, and/or chemicals). Further active substances such as stabilizers, emulsifiers, pigments, bleaching agents, or dyes, can additionally be applied in superimposed layers. Such capsules are applied in accordance with methods known per se, for example, by vibratory or rolling granulation or in fluidized bed processes. Such granulates are advantageously low in dust (e.g., by application of polymeric film-forming agents) and are stable in storage thanks to the coating.

It is furthermore possible to package two or more enzymes together so that a single granulate exhibits several enzyme activities.

As is apparent from the statements above, the enzyme protein constitutes only a fraction of the total weight of usual enzyme preparations. Protease and amylase preparations used in preferred fashion according to the present invention contain from about 0.1 to about 40 wt %, preferably from about 0.2 to about 30 wt %, particularly preferably from about 0.4 to about 20 wt %, and in particular from about 0.8 to about 10 wt % of the enzyme protein.

Examples of formulations for preferred automatic dishwashing agents according to the present invention are illustrated in the tables below:

| | Formu- | Formu- | Formu- | Formu- |
|---|---|---|---|---|
| | lation 25 | lation 26 | lation 27 | lation 28 |
| Ingredient | (wt %) | (wt %) | (wt %) | (wt %) |
| Tripolyphosphate | 5 to 50 | 5 to 35 | 5 to 55 | 5 to 35 |
| Carbonate | 2 to 45 | 2 to 35 | 2 to 35 | 2 to 35 |
| Nonionic surfactant * | 0.1 to 15 | 0.2 to 10 | 0.5 to 8 | 1 to 6 |
| Anionic copolymer ** | 0.1 to 20 | 0.2 to 18 | 0.5 to 15 | 1 to 12 |
| Protease preparation | 0.1 to 12 | 0.2 to 10 | 0.5 to 8 | 0.5 to 8 |
| Amylase preparation | 0.1 to 12 | 0.2 to 10 | 0.5 to 8 | 0.5 to 8 |
| miscellaneous | to 100 | to 100 | to 100 | to 100 |

| | Formu- | Formu- | Formu- | Formu- |
|---|---|---|---|---|
| | lation 28 | lation 29 | lation 30 | lation 31 |
| Ingredient | (wt %) | (wt %) | (wt %) | (wt %) |
| Potassium | 5 to 50 | 5 to 35 | 5 to 55 | 5 to 35 |
| tripolyphosphate | | | | |
| Sodium carbonate | 2 to 45 | 2 to 35 | 2 to 35 | 2 to 35 |
| Nonionic surfactant * | 0.1 to 15 | 0.2 to 10 | 0.5 to 8 | 1 to 6 |
| Anionic copolymer ** | 0.1 to 20 | 0.2 to 18 | 0.5 to 15 | 1 to 12 |
| Protease preparation | 0.1 to 12 | 0.2 to 10 | 0.5 to 8 | 0.5 to 8 |
| Amylase preparation | 0.1 to 12 | 0.2 to 10 | 0.5 to 8 | 0.5 to 8 |
| miscellaneous | to 100 | to 100 | to 100 | to 100 |

R¹O[CH₂CH(CH₃)O]ₓ[CH₂CH₂O]_{y}[CH₂CH(CH₃)O]_{z}CH₂CH(OH)R²

wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; x and z are values from 0 to 40, and y is a value of at least 15.
**Anionic copolymer comprising

i) unsaturated carboxylic acid(s), and

ii) sulfonic acid group-containing monomer(s).

Glass corrosion inhibitors are further preferred ingredients of automatic dishwashing agents according to the present invention. Glass corrosion inhibitors prevent the occurrence of clouding, smearing, and scratches, as well as iridescence, on the glass surface of automatically cleaned glassware. Preferred glass corrosion inhibitors include magnesium and zinc salts and magnesium and zinc complexes.

The spectrum of zinc salts, preferably of organic acids, particularly preferably of organic carboxylic acids, that are preferred according to the present invention extends from salts that are poorly soluble or insoluble in water (i.e., exhibit a solubility below 100 mg/l, by preference below 10 mg/l, in particular below 0.01 mg/l) to those salts that exhibit solubility in water above 100 mg/l, preferably above 500 mg/l, particularly preferably above 1 g/l, and in particular above 5 g/l (all solubilities at a water temperature of 20° C.). Zinc citrate, zinc oleate, and zinc stearate, for example, belong to the first group of zinc salts; zinc formate, zinc acetate, zinc lactate, and zinc gluconate, for example, belong to the group of the soluble zinc salts.

At least one zinc salt of an inorganic or organic carboxylic acid, particularly preferably a zinc salt from zinc stearate, zinc oleate, zinc gluconate, zinc acetate, zinc lactate, and zinc citrate, is used as a glass corrosion inhibitor. Zinc ricinoleate, zinc abietate, and zinc oxalate are also preferred.

In the context of the present invention, zinc salt concentration in washing or cleaning agents is from about 0.1 to about 5 wt %, preferably from about 0.2 to about 4 wt %, and particularly from about 0.4 to about 3 wt %, or the concentration of zinc in oxidized form (calculated as Zn²⁺) is from about 0.01 to about 1 wt %, preferably from about 0.02 to about 0.5 wt %, and particularly from about 0.04 to about 0.5 wt %, based total weight of the glass corrosion inhibitor-containing agent.

As a further ingredient, automatic dishwashing agents according to the present invention can contain an oxygen bleaching agent. Among the compounds that serve as bleaching agents and yield H₂O₂ in water, sodium percarbonate, sodium perborate tetrahydrate, and sodium perborate monohydrate are particularly significant. Other usable bleaching agents include peroxypyrophosphates, citrate perhydrates, and peracid salts or peracids that yield H₂O₂, such as perbenzoates, peroxophthalates, diperazelaic acid, phthaloimino peracid, or diperdodecanedioic acid. Organic bleaching agents can also be used. Typical organic bleaching agents are diacyl peroxides such as dibenzoyl peroxide. Further typical organic bleaching agents are peroxy acids such as alkylperoxy acids and arylperoxy acids.

Preferred automatic dishwashing agents contain, based total weight of the dishwashing agent, about 1.0 to about 20 wt %, preferably about 4.0 to about 18 wt %, and particularly about 8 to about 15 wt % of an oxygen bleaching agent, preferably about 1.0 to about 20 wt %, preferably about 4.0 to about 18 wt %, and in particular about 8 to about 15 wt % sodium percarbonate.

In order to achieve an improved bleaching effect when cleaning at temperatures of about 60° C. and below, automatic dishwashing agents according to the present invention can additionally contain bleach activators. Compounds that, under perhydrolysis conditions, yield aliphatic peroxycarboxylic acids having by preference 1 to 10 carbon atoms, in particular 2 to 4 carbon atoms, and/or optionally substituted perbenzoic acid, can be used as bleach activators. Substances that carry O- and/or N-acyl groups having the aforesaid number of carbon atoms, and/or optionally substituted benzoyl groups, are suitable. Polyacylated alkylenediamines are preferred, tetraacetylethylenediamine (TAED) having proven particularly suitable.

Bleach activators, in particular TAED, are preferably used in quantities of up to about 10 wt %, in particular about 0.1 wt % to about 8 wt %, particularly about 2 to about 8 wt %, and particularly preferably about 2 to about 6 wt %, based in each case on the total weight of the bleach activator-containing agent.

In addition to or instead of conventional bleach activators, so-called bleach catalysts can also be used. These substances are bleach-enhancing transition-metal salts or transition-metal complexes such as, for example, Mn, Fe, Co, Ru, or Mo salen complexes or carbonyl complexes. Mn, Fe, Co, Ru, Mo, Ti, V, and Cu complexes having nitrogen-containing tripod ligands, as well as Co, Fe, Cu, and Ru ammine complexes, are also usable as bleach catalysts.

It is particularly preferred to use manganese complexes in oxidation states II, III, IV, or V, preferably containing one or more macrocyclic ligand(s) having the donor functions N, NR, PR, O, and/or S. Ligands having nitrogen donor functions are preferred. It is particularly preferred to use bleach catalyst(s) containing 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN), and/or 2-methyl-1,4,7-triazacyclononane (Me/TACN) as macromolecular ligands. Suitable manganese complexes include [Mn^{III}₂(μ-O)₁(μ-OAc)₂(TACN)₂](ClO₄)₂, [Mn^{III}Mn^{IV}(μ-O)₂(μ-OAc)₁(TACN)₂](BPh₄)₂, [Mn^{IV}₄(μ-O)₆(TACN)₄](ClO₄)₄, [Mn^{III}₂(μ-O)₁(μ-OAc)₂(Me-TACN)₂](CIO₄)₂, [Mn^{III}Mn^{IV}(μ-O)₁(μ-OAc)₂(Me-TACN)₂](CIO₄)₃, [Mn^{IV}₂(μ-O)₃(Me-TACN)₂](PF₆)₂, and [Mn^{IV}₂(μ-O)₃(Me/Me-TACN)₂](PF₆)₂(OAc═OC(O)CH₃).

Automatic dishwashing agents further containing a bleach catalyst chosen from bleach-enhancing transition-metal salts and transition-metal complexes, preferably from manganese complexes with 1,4,7-trimethyl-1,4,7-triazacyclononane (Me₃-TACN) or 1,2,4,7-tetramethyl-1,4,7-triazacyclononane (Me₄-TACN), are preferred according to the present invention, since cleaning results can be significantly improved with these bleach catalysts.

Automatic dishwashing agents used according to the present invention can be prepared in solid or liquid form, as well as a combination of solid and liquid presentation forms.

Powders, granulates, extrudates, or compactates, particularly tablets, are especially suitable as solid presentation forms. Liquid presentation forms, preferably based on water and/or organic solvents, can exist in thickened form as gels.

Aqueous automatic dishwashing agents are preferred according to the present invention. Water content of these aqueous automatic dishwashing agents, based on total weight of the automatic dishwashing agent, is preferably from about 10 to about 80 wt %, by preference from about 20 to about 70 wt %, and in particular from about 30 to about 60 wt %.

Because elevated alkalinity of the automatic dishwashing agent contributes to the cleaning performance of that agent, but also to the corrosive and irritating effect of that agent, preferred automatic dishwashing agents according to the present invention have a pH (20° C.) from about 8 to about 12, preferably from about 9 to about 11.5, more preferably from about 9.5 to about 11.5. Automatic dishwashing agents in the form of a liquid, aqueous, low-alkalinity preparation having a pH (20° C.) from about 8 to about 12, preferably from about 9 to about 11.5, more preferably from about 9.5 to about 11.5, are particularly preferred.

Cleaning performance of automatic dishwashing agents according to the present invention can be improved by addition of organic solvents. A preferred embodiment of the present invention is therefore automatic dishwashing agents that, in addition to the other ingredients mentioned, further contain at least one organic solvent. Preferred liquid automatic dishwashing agents contain, based on total weight of the agent, organic solvent in quantities from about 0.2 to about 15 wt %, by preference about 0.5 to about 12 wt %, particularly preferably about 1.0 to about 10 wt %.

These organic solvents derive, for example, from monoalcohols, diols, triols or polyols, the ethers, esters, and/or amides. Organic solvents that are water-soluble are particularly preferred in this context, “water-soluble” solvents for purposes of the present application being solvents that are completely miscible with water (i.e., with no miscibility gap) at room temperature.

Organic solvents that can be used in agents according to the present invention derive preferably from monovalent or polyvalent alcohols, alkanolamines, or glycol ethers, provided they are miscible with water in the indicated concentration range. The solvents are preferably chosen from ethanol, n-propanol or isopropanol, butanols, glycol, propanediol or butanediol, in particular 1,2-propanediol, glycerol, diglycol, propyl or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, or propylene glycol propyl ether, dipropylene glycol methyl ether or dipropylene glycol ethyl ether, methoxytriglycol, ethoxytriglycol, or butoxytriglycol, 1-butoxyethoxy-2-propanol, 3-methyl-3-methoxybutanol, propylene glycol t-butyl ether, and mixtures of these solvents.

Organic solvents from organic amines and/or alkanolamines are effective in cleaning performance, and particularly with regard to cleaning performance on bleachable stains, in particular on tea stains.

Preferred organic amines include, in particular, primary and secondary alkylamines, alkylenamines, and mixtures of said organic amines. Included in the group of the preferred primary alkylamines are monomethylamine, monoethylamine, monopropylamine, monobutylamine, monopentylamine, and cyclohexylamine. Preferred secondary alkylamines include dimethylamine.

Preferred alkanolamines are, in particular, primary, secondary and tertiary alkanolamines and mixtures thereof. Particularly preferred primary alkanolamines are monoethanolamine (2-aminoethanol, MEA), monoisopropanolamine, diethylethanolamine (2-(diethylamino)ethanol). Particularly preferred secondary alkanolamines are diethanolamine (2,2′-iminodiethanol, DEA, bis(2-hydroxyethyl)amine), N-methyldiethanolamine, N-ethyldiethanolamine, diisopropanolamine, and morpholine. Particularly preferred tertiary alkanolamines are triethanolamine and triisopropanolamine.

The weight proportion of alkanolamine based on total weight of automatic dishwashing agents according to the present invention is about 0.1 to about 10 wt %, by preference about 0.2 to about 8 wt %, preferably about 0.4 to about 6 wt %, and in particular about 1 to about 5 wt %.

In order to achieve the desired viscosity for automatic dishwashing agent according to the present invention, thickening agents can be added thereto.

Particularly preferred thickening agents are synthetic polymers such as polyacrylic and polymethacrylic compounds, vinyl polymers, polycarboxylic acids, polyethers, polyimines, polyamides, and polyurethanes. Thickening agents from these substance classes are commercially available, for example, under the commercial names Acusol® 810, Acusol® 820 (methacrylic acid [stearyl alcohol 20 EO] ester/acrylic acid copolymer, 30% in water, Rohm & Haas), Dapral® GT-282-S (alkylpolyglycol ether, Akzo), Deuterol® Polymer 11 (dicarboxylic acid copolymer, Schöner GmbH), Deuteron® XG (anionic heteropolysaccharide based on β-D-glucose, D-mannose, D-glucuronic acid, Schöner GmbH), Deuteron® XN (nonionogenic polysaccharide, Schöner GmbH), Dicrylan® Thickener O (ethylene oxide adduct, 50% in water/isopropanol, Pfersse Chemie), EMA® 81 and EMA® 91 (ethylene-maleic acid anhydride copolymer, Monsanto), QR-1001 thickener (polyurethane emulsion, 19 to 21% in water/diglycol ether, Rohm & Haas), Mirox® AM (anionic acrylic acid-acrylic acid ester copolymer dispersion, 25% in water, Stockhausen), SER AD FX 1100 (hydrophobic urethane polymer, Servo Delden), Shellflo® S (high-molecular-weight polysaccharide stabilized with formaldehyde, Shell), and Shellflo® XA (xanthan biopolymer stabilized with formaldehyde, Shell).

Examples of further thickening agents include agar-agar, carrageenan, tragacanth, gum arabic, alginates, pectins, polyoses, guar flour, locust bean flour, starch, dextrins, gelatins, casein, carboxymethyl cellulose, seed flour ethers, polyacrylic and polymethacrylic compounds, vinyl polymers, polycarboxylic acids, polyethers, polyimines, polyamides, polysilicic acids, clay minerals such as montmorillonites, zeolites, and silicic acids.

It has proven to be particularly advantageous if the automatic dishwashing agents according to the present invention contain the thickening agent in quantities from about 0.1 to about 8 wt %, preferably from about 0.2 to about 6 wt %, and particularly preferably from about 0.4 to about 4 wt %, based on total weight of the automatic dishwashing agent.

Pourability and settling stability of liquid automatic dishwashing agents according to the present invention can be influenced not only by thickeners but also by the ratio of potassium and sodium ions in said agents. Liquid automatic dishwashing agents preferred according to the present invention having a ratio of potassium to sodium ions above about 1:1, by preference above about 2:1, particularly preferably above about 4:1, and in particular above about 8:1, have proven advantageous.

Preparation and packaging of liquid agents according to the present invention can be accomplished using water-soluble or water-insoluble packaging known to one skilled in the art. The packaging can be single-, dual-, or multi-chamber containers.

Water-insoluble dual- or multi-chamber containers are particularly preferred. Dual- or multi-chamber containers of this kind typically have a total volume from about 100 to about 5000 ml, by preference from about 200 to about 2000 ml. Volume of the individual chambers is by preference from about 50 to about 2000 ml, preferably from about 100 to about 1000 ml. Preferred dual- or multi-chamber containers are bottle-shaped. Automatic dishwashing agents according to the present invention are present in these packaging means preferably in the form of sub-formulations separated from one another. These sub-formulations do not form shared phase boundaries, but instead are located in regions of the packaging separate from one another, and have compositions that differ from one another.

For dispensing of the liquid automatic dishwashing agents, dual- or multi-chamber container preferably have at least one pouring spout which can be configured, for example, in the form of one shared pouring spout for all the agents contained in the bottle. Dual- or multi-chamber containers in which each of the receiving chambers of the container possesses its own pouring spout are, however, preferred. Such a configuration avoids, for example, contamination of individual chambers by ingredients from another chamber.

A further preferred subject of the present application is therefore a liquid, low-alkalinity automatic dishwashing agent having a pH (20° C.) of from about 8 to about 12, containing

a) about 10 to about 60 wt % of one or more builders,
b) nonionic surfactant of the general formula

R¹O[CH₂CH(CH₃)O]_{X}[CH₂CH₂O]_{y}[CH₂CH(CH₃)O]_{z}CH₂CH(OH)R²
wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; x and z are values from 0 to 40, and y is a value of at least 15, and
   c) anionic copolymer comprising

i) unsaturated carboxylic acid(s),

ii) sulfonic acid group-containing monomer(s),

wherein the automatic dishwashing agent is present in a dual- or multi-chamber container whose individual chambers are filled with sub-formulations of the automatic dishwashing agent.

Weight indications set forth above for the ingredients having washing and cleaning activity and pH information refer to the automatic dishwashing agent obtained by combining all the sub-formulations. In packaging with a dual- or multi-chamber container as described above, individual sub-formulations contained in the chambers can therefore deviate from the features characterizing automatic dishwashing agents according to the present invention, provided only that the combination of all sub-formulations yields an automatic dishwashing agent according to the present invention having the (and, if applicable, preferred) features recited above.

For example, individual sub-formulations can be free of phosphonate or of anionic copolymer, provided the combination of all sub-formulations yields an automatic dishwashing agent that contains nonionic surfactant b) and anionic copolymer encompassing i) unsaturated carboxylic acid(s) and ii) sulfonic acid group-containing monomer(s).

The information set forth above regarding pH of low-alkalinity dishwashing agents preferred according to the present invention also refers to the pH of the overall composition, and not to the pH of any sub-formulations. Individual sub-formulations may therefore exhibit pH values (20° C.) below 8 or above 12, provided the combination of the sub-formulations yields an automatic dishwashing agent that has a pH (20° C.) from about 8 to about 12.

In packaging automatic dishwashing agents according to the present invention into dual- or multi-chamber containers, it has proven advantageous for stability of any enzymes contained in the agents to package those enzymes together with a nonionic surfactant in one of the chambers of the container. It has been possible to improve the cleaning performance of said agents by combined packaging of the enzyme and surfactant.

Examples of formulations for automatic dishwashing agents preferred in this fashion are illustrated in the tables below:

| | Automatic dishwashing agent 1 | | Automatic dishwashing agent 2 | |
|---|---|---|---|---|
| | Sub-formulation | Sub-formulation | Sub-formulation | Sub-formulation |
| Ingredient | 1 (wt %) | 2 (wt %) | 1 (wt %) | 2 (wt %) |
| Tripolyphosphate | 3 to 40 | 3 to 30 | 3 to 30 | 2 to 15 |
| Carbonate | 0 to 10 | 3 to 20 | — | 4 to 15 |
| Nonionic surfactant * | 0.1 to 15 | 0 to 4 | 0.5 to 8 | — |
| Anionic copolymer ** | 0 to 10 | 0.2 to 18 | — | 1 to 12 |
| Enzyme preparation | 0.1 to 12 | — | 0.5 to 8 | — |
| Water | 10 to 80 | 20 to 70 | 30 to 70 | 30 to 70 |
| miscellaneous | to 100 | to 100 | to 100 | to 100 |

| | Automatic dishwashing agent 3 | | Automatic dishwashing agent 4 | |
|---|---|---|---|---|
| | Sub-formulation | Sub-formulation | Sub-formulation | Sub-formulation |
| Ingredient | 1 (wt %) | 2 (wt %) | 1 (wt %) | 2 (wt %) |
| Potassium | 3 to 40 | 3 to 30 | 3 to 30 | 2 to 15 |
| tripolyphosphate | | | | |
| Sodium carbonate | 0 to 10 | 3 to 20 | — | 4 to 15 |
| Nonionic surfactant * | 0.1 to 15 | 0 to 4 | 0.5 to 8 | — |
| Anionic copolymer ** | 0 to 10 | 0.2 to 18 | — | 1 to 12 |
| Enzyme preparation | 0.1 to 12 | — | 0.5 to 8 | — |
| Water | 10 to 80 | 20 to 70 | 30 to 70 | 30 to 70 |
| miscellaneous | to 100 | to 100 | to 100 | to 100 |

| | Automatic dishwashing agent 5 | | Automatic dishwashing agent 6 | |
|---|---|---|---|---|
| | Sub-formulation | Sub-formulation | Sub-formulation | Sub-formulation |
| Ingredient | 1 (wt %) | 2 (wt %) | 1 (wt %) | 2 (wt %) |
| Tripolyphosphate | 3 to 40 | 3 to 30 | 3 to 30 | 2 to 15 |
| Carbonate | 0 to 10 | 3 to 20 | — | 4 to 15 |
| HEDP | 0 to 4 | 2 to 6 | 0 to 4 | 2 to 6 |
| Nonionic surfactant * | 0.1 to 15 | 0 to 4 | 0.5 to 8 | — |
| Anionic copolymer ** | 0 to 10 | 0.2 to 18 | — | 1 to 12 |
| Protease preparation | 0.1 to 12 | — | 0.5 to 8 | — |
| Amylase preparation | 0.1 to 12 | — | 0.5 to 8 | — |
| Alkanolamine | — | 0.2 to 8 | — | 1 to 5 |
| Water | 10 to 80 | 20 to 70 | 30 to 70 | 30 to 70 |
| miscellaneous | to 100 | to 100 | to 100 | to 100 |

| | Automatic dishwashing agent 7 | | Automatic dishwashing agent 8 | |
|---|---|---|---|---|
| | Sub-formulation | Sub-formulation | Sub-formulation | Sub-formulation |
| Ingredient | 1 (wt %) | 2 (wt %) | 1 (wt %) | 2 (wt %) |
| Potassium | 3 to 40 | 3 to 30 | 3 to 30 | 2 to 15 |
| tripolyphosphate | | | | |
| Sodium carbonate | 0 to 10 | 3 to 20 | — | 4 to 15 |
| HEDP | 0 to 4 | 2 to 6 | 0 to 4 | 2 to 6 |
| Nonionic surfactant * | 0.1 to 15 | 0 to 4 | 0.5 to 8 | — |
| Anionic copolymer ** | 0 to 10 | 0.2 to 18 | — | 1 to 12 |
| Protease preparation | 0.1 to 12 | — | 0.5 to 8 | — |
| Amylase preparation | 0.1 to 12 | — | 0.5 to 8 | — |
| Alkanolamine | — | 0.2 to 8 | — | 1 to 5 |
| Water | 10 to 80 | 20 to 70 | 30 to 70 | 30 to 70 |
| miscellaneous | to 100 | to 100 | to 100 | to 100 |

R¹O[CH₂CH(CH₃)O]ₓ[CH₂CH₂O]_{y}[CH₂CH(CH₃)O]_{z}CH₂CH(OH)R²

wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; x and z are values from 0 to 40, and y is a value of at least 15.
**Anionic copolymer comprising

i) unsaturated carboxylic acid(s), and

ii) sulfonic acid group-containing monomer(s).

A further aspect of the present invention is a process for cleaning tableware in an automatic dishwasher utilizing automatic dishwashing agents according to the present invention. Here, the automatic dishwashing agents are dispensed into the interior of an automatic dishwasher, preferably during execution of a dishwashing program, before beginning the main washing cycle, or during the main washing cycle. Dispensing or introduction of the agent into the interior of the automatic dishwasher can be accomplished manually, but is preferably dispensed into the interior of the automatic dishwasher by the dispensing chamber of the automatic dishwasher. By preference, no additional water softener and no additional rinsing agent are dispensed into the interior of the automatic dishwasher in the course of the cleaning process. A kit for an automatic dishwasher, encompassing
a) an automatic dishwashing agent according to the present invention; and
b) an instruction notifying the consumer that the automatic dishwashing agent is to be used without the addition of a rinsing agent and/or a water-softener salt,
   is a further subject of this application.

Automatic dishwashing agents according to the present invention exhibit their advantageous cleaning properties particularly in low-temperature cleaning processes. Preferred dishwashing processes using agents according to the present invention are carried out at temperatures up to a maximum of about 55° C., preferably up to a maximum of about 50° C.

As described earlier, agents according to the present invention are notable for improved cleaning performance on bleachable stains versus conventional automatic dishwashing agents. A further aspect of the present invention is therefore use of an automatic dishwashing agent according to the present invention for improving drying in automatic dishwashing.

### EXAMPLES

Performance of an automatic dishwashing agent with regard to drying, deposits, and cleaning was determined as a function of the manner of dispensing of the automatic dishwashing agent that was used.

For this purpose, tableware was washed in an automatic dishwasher (Miele 1730; 55° normal 3-in-1 program, extra drying) using 33 ml (16.5 ml V1N2 or 16.5 ml E1/E2, respectively) of an automatic dishwashing agent at a water hardness of 21° dH. The dishwashing agents were dispensed in during the main washing cycle of the dishwashing process.

Compositions of dishwashing agents E and V that were used are provided in the table below:

| | Cleaning agent V | | Cleaning agent E | |
|---|---|---|---|---|
| | (mixture of 50 wt % | | (mixture of 50 wt % | |
| | V1 and 50 wt % V2) | | E1 and 50 wt % E2) | |
| Raw material | V1 (wt %) | V2 (wt %) | E1 (wt %) | E2 (wt %) |
| KTTP | 17.5 | 10.0 | 17.5 | 10.0 |
| Nonionic surfactant ¹ | — | — | 4.0 | — |
| Nonionic surfactant ² | 4.0 | — | — | — |
| Protease | 2.0 | — | 2.0 | — |
| Amylase | 1.0 | — | 1.0 | — |
| Phosphonate | 3.0 | 5.0 | 3.0 | 5.0 |
| Thickener | 4.0 | — | 4.0 | — |
| Organic solvent | 3.0 | 3.0 | 3.0 | 3.0 |
| Anionic polymer | — | 8.6 | — | 8.6 |
| Soda | — | 7.0 | — | 7.0 |
| water, misc. | to 100 | to 100 | to 100 | to 100 |

¹ Hydroxy mixed ethers of the general formula C₆₋₂₂—CH(OH)CH₂O-(EO)₂₀₋₁₂₀-C₂₋₂₆
² Polyoxyalkylated fatty alcohol

Regarding cleaning performance (determined per IKW), no significant differences were ascertained between the two process variants. The drying index was determined according to the EN standard (maximum value for best drying=1.0). The results are indicated in the table below (the values indicated were derived as averages of three experiments):

| | V1 | E1 |
|---|---|---|
| Drying index | 0.40 | 0.60 |
| Deposit formation | deposits | no deposits |

We claim:

1. Automatic dishwashing agent comprising:
a) about 10 to about 60 wt % of one or more builders,
b) a nonionic surfactant of the general formula
R¹O[CH₂CH(CH₃)O]ₓ[CH₂CH₂O]_{y}[CH₂CH(CH₃)O]_{z}CH₂CH(OH)R²
wherein R¹ is a linear or branched aliphatic hydrocarbon residue having 4 to 22 carbon atoms, or mixtures thereof; R² is a linear or branched hydrocarbon residue having 2 to 26 carbon atoms, or mixtures thereof; x and z are values from 0 to 40, and y is a value of at least 15,
c) an anionic copolymer comprising
i) unsaturated carboxylic acids,
ii) sulfonic acid group-containing monomers,
wherein the weight ratio of the anionic copolymer and nonionic surfactant is less than 3:1.

2. Automatic dishwashing agent according to claim 1, wherein the weight ratio of the anionic copolymer and nonionic surfactant is less than 2.8:1.

3. Automatic dishwashing agent according to claim 1, wherein the nonionic surfactant is a surfactant of the general formula
R¹O[CH₂CH₂O]_{y}CH₂CH(OH)R²
wherein R¹ is a linear or branched aliphatic hydrocarbon residue having 4 to 22 carbon atoms, or mixtures thereof, R² is a linear or branched hydrocarbon residue having 2 to 26 carbon atoms, or mixtures thereof, and y is a value from 15 to 120.

4. Automatic dishwashing agent according to claim 1, wherein the nonionic surfactant is a surfactant of the general formula
R¹O[CH₂CH(CH₃)O]_{X}[CH₂CH₂O]_{y}CH₂CH(OH)R²
in which R¹ is a linear or branched aliphatic hydrocarbon residue having 4 to 22 carbon atoms, or mixtures thereof, R² is a linear or branched hydrocarbon residue having 2 to 26 carbon atoms, or mixtures thereof, x is a value from 0.5 to 4, and y is a value of at least 15.

5. Automatic dishwashing agent according to claim 1, wherein the nonionic surfactant is a surfactant of the general formula
R¹O[CH₂CH(CH₃)O]ₓ[CH₂CH₂O]_{y}CH₂CH(OH)R²
wherein R¹ is a linear or branched aliphatic hydrocarbon residue having 4 to 22 carbon atoms, or mixtures thereof, R² is a linear or branched hydrocarbon residue having 2 to 26 carbon atoms, or mixtures thereof, x is a value from 1 to 40, and y is a value between 15 and 40, wherein the alkylene units [CH₂CH(CH₃)O] and [CH₂CH₂O] are present in random fashion.

6. Automatic dishwashing agent according to claim 1, wherein the nonionic surfactant is present in an amount from about 0.1 to about 15 wt %.

7. Automatic dishwashing agent according to claim 1, wherein the anionic polymer is a copolymer comprising:
i) unsaturated carboxylic acids,
ii) sulfonic acid group-containing monomers, and
iii) nonionogenic monomers.

8. Automatic dishwashing agent according to claim 1, wherein the anionic polymer is present in an amount of about 0.2 to 18 wt %, based on total weight of the agent.

9. Automatic dishwashing agent according to claim 1, further comprising from 0.5 to 10 wt % phosphonate, based on total weight of the agent.

10. Automatic dishwashing agent according to claim 1, further comprising from 0.1 to 12 wt % enzyme, based on total weight of the agent.

11. Automatic dishwashing agent according to claim 1, wherein the agent is in the form of a liquid, aqueous, low-alkalinity preparation having a pH (20° C.) from about 8 to about 12.

12. Process for cleaning tableware in an automatic dishwasher comprising washing the tableware with an automatic dishwashing agent according to claim 1.

13. Process according to claim 12, wherein no additional water softener and no additional rinsing agent are dispensed into the interior of the automatic dishwasher during the washing process.

14. Process according to claim 12, wherein said process is carried out at temperatures up to about 55° C.
